(19) United States
(12) Patent Application Publication
(10) Pub. No.: US 2015/0073108 A1
(43) Pub. Date: Mar. 12, 2015

(54) HIGH SURFACE AREA SILICON DERIVATIVE FREE MAGNESIUM- TITANIUM CATALYST SYSTEM FOR ETHYLENE POLYMERIZATION AND PROCESS OF PREPARATION THEREOF

(71) Applicants: Harshad Ramdas Patil, Surat (IN); Virendrakumar Gupta, Navi Mumbai (IN); Ajay Vinoklal Kothari, Gujarat (IN)

(72) Inventors: Harshad Ramdas Patil, Surat (IN); Virendrakumar Gupta, Navi Mumbai (IN); Ajay Vinoklal Kothari, Gujarat (IN)

(73) Assignee: Reliance Industries Limited, Mumbai (IN)

(21) Appl. No.: 14/367,102

(22) PCT Filed: Jul. 26, 2012
(86) PCT No.: PCT/IN2012/000519

§ 371 Date: Oct. 14, 2014

(30) Foreign Application Priority Data
Dec. 21, 2011 (IN) 3585/MUM/2011

(51) Int. Cl. C08F 110/02

(52) U.S. Cl. CPC C08F 110/02
USPC 526/124.6; 502/103; 502/126; 502/104

(57) ABSTRACT

The present invention relates to a high surface area silicon derivative free magnesium-titanium catalyst system for ethylene polymerization comprising: magnesium mixed alkoxide and titanium chloride. The present invention also provides a simple process for the preparation of high surface area silicon derivative free magnesium-titanium catalyst system for ethylene polymerization by reacting magnesium alkoxide precursor with titanium compound using dialkyl dialkoxy silane as external donor. The invention further relates to the process for ethylene polymerization using the silicon derivative free magnesium-titanium catalyst system and polyethylene produced by the catalyst system having narrow molecular weight distribution and higher bulk density.

### FIELD OF THE INVENTION

The present invention relates to a high surface area silicon derivative free magnesium-titanium catalyst system for ethylene polymerization and process of preparation thereof. The present invention provides a single step process for the preparation of high surface area silicon derivative free magnesium-titanium catalyst system for ethylene polymerization. The present invention also relates to the process of polymerization using the high surface area silicon derivative free magnesium-titanium catalyst system and the polyethylene produced by the catalyst system.

### BACKGROUND OF THE INVENTION

JP55149307A (Idemitsu Kosan Co. Ltd.) discloses a method for the preparation of high-quality and high-density polyethylene by a method wherein ethylene is polymerized using a catalyst comprising a reaction product of magnesium alkoxide pretreated with a silicon derivative compound and a titanium halide and an organic aluminum compound.

JP2003405B (To a Nenryo Kogyo) discloses a catalyst component for polymerizing olefin, comprises contacting magnesium alkoxide, silicon derivative compound with H—Si bond and titanium compound. The catalyst is useful for manufacture of polyolefin, especially isotactic polypropylene random copolymer of ethylene with propylene and block copolymer of ethylene with propylene.

CA1243657A (To a Nenryo Kogyo) teaches a catalyst component for polymerization of olefins which is prepared by contacting a product obtained by contacting a magnesium alkoxide, a silicon derivative compound having the hydrogen-silicon derivative bond, and a titanium compound with one another, with (a) a hydrocarbon, (b) a halogenated hydrocarbon, and/or (c) a halide of an element selected from the elements of Groups IIIa, IVa, and Va of the Periodic Table.

WO2001000687A1 (Union Carbide Chemicals & Plastics Technology Corporation) discloses complexes of magnesium and titanium alkoxides useful as olefin polymerization procatalyst precursors, procatalysts containing the complexes, and their use as a catalyst components for the polymerization of olefin monomers. The complexes are prepared by reacting a magnesium alkoxide and a titanium alkoxide in the presence of a clipping agent to form a solid complex. The solid complex can be used to form a procatalyst by contacting it with a halogenating agent, optionally a tetravalent titanium halide, and optionally an electron donor. The procatalyst then can be converted to an olefin polymerization catalyst by contacting it with a cocatalyst and optionally a selectivity control agent.

U.S. Pat. No. 4,771,024A (Shell Oil Company) discloses olefin polymerization catalyst components having improved activity and morphological properties. In particular, the components are prepared by reacting, a carbonized magnesium alkoxide or aryloxide component with a halogenated tetravalent titanium component, a halohydrocarbon component and an electron donor.

U.S. Pat. No. 5,371,157A (JOB; Robert C) discloses a high activity olefin polymerization catalyst useful in the polymerization of lower α-olefins; comprising the solid product resulting from contacting a complex magnesium-containing, titanium-containing alkoxide compound with alkylaluminum halide, optionally employed in conjunction with a selectivity control agent.

EP262935B1 (Neste Oy) discloses catalyst components for α-olefin polymerization catalysts comprising an organo-aluminium compound, an electron donor and a solid catalyst component obtained by reaction of a magnesium-containing compound with a titanium halogen compound, are prepared by the steps of reacting a magnesium alkyl compound with a chlorinating compound; dissolving the chlorinated magnesium alkyl compound in alcohol, optionally after washing adding to the solution obtained with uncalcined magnesium silicate; adding the mixture obtained to a cold medium to precipitate the magnesium compound on the magnesium silicate carrier; separating the resultant solid carrier component and reacting the solid carrier component with a titanium halogen compound in the presence of an internal electron donor.

U.S. Pat. No. 6,511,935B2 (Union Carbide Chemicals & Plastics Technology) discloses process of making magnesium/transition metal alkoxide complexes and polymerization catalysts prepared therefrom. An olefin polymerization procatalyst is prepared by halogenating a precursor comprising a complex of magnesium, transition metal and alkoxide in a single step using a boron trihalide or in a multi-step process using alkyl aluminum halides, titanium or silicon derivative tetrahalides or bromine. The patent discloses partial titanation of magnesium alkoxide or carbonated magnesium precursor followed by total chlorination. Aluminum alkyl is also contacted during catalyst synthesis. Ethylene polymerization is performed without using silanes.

U.S. Pat. No. 7,326,757B2 (BASF Catalysts) discloses supported catalyst for olefin polymerization. Titanium tetrahalide reacts in drop-wise manner with magnesium alcohol adduct, optionally an internal donor is present. The use of organo-silicon derivative compound as external donor is optional.

Reaction of magnesium ethoxide with titanium tetrachloride and silicon tetrachloride in multiple steps for synthesis of PE catalyst is known. Use of external donors for ethylene polymerization is also known in prior art. WO2009027270A1 (Basell Poliolefine, 19 Aug. 2008) relates to catalysts for the polymerization of olefins, in particular ethylene and its mixtures with olefins CH₂═CHR, wherein R is an alkyl, cycloalkyl or aryl radical having 1-12 carbon atoms, comprising a solid catalyst component comprising Ti, Mg, halogen and optionally an electron donor, an aluminum alkyl compound and a particular class of silanes compounds as external electron donor compounds. The catalysts of the invention are suitably used in (co)polymerization processes of ethylene to prepare (copolymers having narrow Molecular Weight Distribution (MWD) and high activity. The method described in this application includes MgCl₂ and alcohol route for synthesis of catalyst. It is prepolymerized with propylene and polymerization was carried out with ethylene.

U.S. Pat. No. 7,196,152 (Alt et. al., 27 Mar. 2007) discloses synthesis of catalyst system containing magnesium, titanium, silicon and aluminum. DMDPS (dimethoxydiphenylsilane), DEDES (diethoxydiethylsilane), DMDiBS (dimethoxydiisobutly silane), DMDcPS (dimethyldicyclopenylsilane) and TES (tetraethoxysilane) were used as external donor during polymerization. These external donors narrowed molecular weight distribution—due to less formation of lower weight average molecular weight polyethylene (or wax). However, such external donors have shown reduction of catalyst productivity which results in higher consumption of catalyst for polymerization of ethylene compared to one without use of external donor or silicon derivative free magnesium titanium catalyst. It also indicates lowering of bulk density.

Slurry phase ethylene polymerization is generally carried out using catalyst system consisting of magnesium, titanium and oxygen species. The catalyst synthesis methodology used involves multiple steps reaction requiring longer reaction time. During polymerization, low molecular weight species is formed along with desired molecular weight polyethylene. Wax (low molecular weight polymer) formation generally fouls the reactor wall which leads to lowering of heat transfer which reduces commercial plant throughput. This generally also leads to lower flowability of polymer resin. Use of external donor with silicon derivative modified magnesium-titanium catalyst reduces low molecular weight polymer, but leads to lower productivity and bulk density.

Therefore, it is desirable to have simplified catalyst system involving less reaction steps and ability to reduce molecular weight density.

### STATEMENT OF THE INVENTION

The present invention provides a high surface area silicon derivative free magnesium-titanium catalyst system and a process for preparing the high surface area silicon derivative free magnesium-titanium catalyst system for ethylene polymerization. The present invention further provides a process for, ethylene polymerization; and a polymer obtained using the high surface area silicon derivative free magnesium-titanium catalyst system for ethylene polymerization. The invention also provides a high surface area silicon derivative free magnesium-titanium catalyst system for ethylene polymerization prepared by the process described herein.

### OBJECTS OF THE INVENTION

An important object of the present invention is to provide a simple catalyst system for ethylene polymerization which reduces reactor fouling.

Another object of the present invention is to provide a high surface area silicon derivative free magnesium-titanium catalyst system for ethylene polymerization.

Still another object of the present invention is to provide a simple process for the preparation of high surface area silicon derivative free magnesium-titanium catalyst system for ethylene polymerization.

A further object of the present invention is to provide a single-step process for the preparation of magnesium-titanium catalyst system with lower reaction time.

Yet another object of the present invention is to provide a process of polymerization using the high surface area silicon derivative free magnesium-titanium catalyst system

Another object of the present invention is to prepare a polyethylene having narrow molecular weight distribution and higher bulk density using the disclosed catalyst system Still another object of the present invention is to provide very high molecular weight polyethylene using disclosed catalyst.

### SUMMARY OF THE INVENTION

The above and other objects of the present invention are achieved by providing a high surface area silicon derivative free magnesium-titanium catalyst system for ethylene polymerization and process of preparation thereof. The process for the preparation of high surface area silicon derivative free magnesium-titanium catalyst system for ethylene polymerization comprises reacting mixed alkoxide precursor [Mg(OR₁)(OR₂) e.g. R₁=ethoxy, R₂=methoxy, propoxy, butoxy]: magnesium alkoxide precursor with titanium compound using alkoxy silane as external donor.

The present invention provides a silicon derivative free magnesium-titanium catalyst system prepared by simplified single step process. The catalyst system of the present invention has high surface area and shorter reaction time (using magnesium ethoxide route). Polymerization is performed without pre-polymerization using alkoxy silanes.

The catalyst system of the present invention shows narrowing of molecular weight of produced polyethylene. Compared to prior art, the polyethylene produced has an increase in productivity and in bulk density. Thus, the present invention obviates the disadvantages of the prior art and has an inventive merit over the catalyst systems of the prior art.

In an embodiment the present invention provides a high surface area silicon derivative free magnesium-titanium catalyst system for ethylene polymerization comprising: magnesium mixed alkoxide of formula Mg(OR₁)(OR₂) wherein R₁ is ethoxy, R₂ is methoxy, propoxy or butoxy; and titanium chloride.

In another embodiment the catalyst system of present invention comprises 19 to 23 wt % of magnesium; 66 to 72 wt % of ethoxy; 5 to 9 wt % of methoxy; has a molecular weight of about 112 g/mol; and mean particle size of about 15-80 micron.

In yet another embodiment the ratios of magnesium:titanium:chloride:alkoxide on mol basis is: 1:0.28 to 32:2.7 to 3.0:0.1 to 0.6.

In still another embodiment of present invention the surface area of catalyst system is in the range of 490 to 520 m²/g.

In another embodiment the porosity of catalyst system is in the range of 0.38 to 0.48 cm³/g.

In yet another embodiment the present invention provides a catalyst system which prevents formation of low molecular weight polymer and reduces fouling of reactor.

In still another embodiment the catalyst system further comprises external donor dialkyl dialkoxy silane of formula R₁₍₂₎(Si)OR₂₍₂₎ wherein R₁ is alkyl or aryl group and R₂ is alkyl group; and a co-catalyst.

In another embodiment dialkyl dialkoxy silane is selected from the group comprising dimethyl dimethoxy silane, diethyl diethoxy silane, diisoproyl dimethoxy silane, diisopropyl diethoxy silane, dipropyl dimethoxy silane, dipropyl diethoxy silane, dibutyl dimethoxy silane, dibutyl diethoxy silane or combinations thereof.

In yet another embodiment the co-catalyst is triethyl aluminum.

In a further embodiment the present invention provides a process for preparing high surface area silicon derivative free magnesium-titanium catalyst system for ethylene polymerization comprising reacting about 0.089 mole magnesium mixed alkoxide with about 0.54 mole titanium chloride in chlorobenzene; settling for about 30 to 60 minutes; separating liquid; washing for removing free titanium; and drying.

In still another embodiment of present invention magnesium mixed alkoxide comprises 19 to 23 wt % of magnesium; 66 to 72 wt % of ethoxy; 5 to 9 wt % of methoxy; has a molecular weight of about 112 g/mol; mean particle size of about 15-80 micron; and said titanium chloride has a molecular weight of about 190 g/mol.

In another embodiment of present invention magnesium mixed alkoxide is reacted with titanium chloride in chlorobenzene at about 110° C. for about 120 min at about 100 rpm.

In yet another embodiment of present invention separation of liquid is done by decantation.

In still another embodiment washing for removing free titanium is done with chlorobenzene and hexane.

In a further embodiment of present invention drying is in nitrogen steam.

In another embodiment the process for preparing the catalyst system further comprises adding external donor dialkyl dialkoxy silane of formula R₁₍₂₎(Si)OR₂₍₂₎ wherein R₁ is alkyl or aryl group and R₂ is alkyl group; and the co-catalyst is triethyl aluminum.

In yet another embodiment the present invention provides a high surface area silicon derivative free magnesium-titanium catalyst system prepared by the process disclosed herein.

In still another embodiment the present invention provides a process for ethylene polymerization comprising: (a) charging n-hexane into a reactor; (b) saturating the reactor with ethylene; (c) adding the catalyst system as claimed in claim 16 into said reactor; (d) adding hydrogen to achieve 1 bar reactor pressure; (e) maintaining reactor temperature at about 60±2° C. with total pressure of about 6±0.1 bar (ethylene pressure=5±0.1 bar) for about 1 hr. at 400 rpm; (f) depressurizing the reactor; (g) cooling to room temperature to obtain slurry; (h) filtering the slurry to obtain polymer; and (i) drying the polymer.

In yet another embodiment the reactor used in process for ethylene polymerization is a Continuous Stirred Tank Reactor.

In an embodiment n-hexane is charged into reactor for about 10 min.

In another embodiment the activity for ethylene polymerization is about 4600 gPE/gcat.

In still another embodiment of present invention polymer obtained has narrow molecular weight distribution in the range of 3.8 to 4.2 and high bulk density in the range of 0.33 to 0.36.

### BRIEF DESCRIPTION OF FIGURES

FIG. 1: Flowability study for resin produced with and without external donor: Resin produced by DMDMS flow through slit in 7.3 second compared to resin produced without external donor which takes 9.4 seconds indicating better flowability of resin.

FIG. 2: Morphology study of precursor, procatalyst and resin (with and without external donor): Surface of resin is visibly smoother in case of resin produced by DMDMS as compared to resin produced without use of external donor.

### DETAILED DESCRIPTION OF THE INVENTION

The present invention discloses a high surface area silicon derivative free magnesium-titanium catalyst system for ethylene polymerization. The disclosed catalyst system reduces reactor fouling by preventing formation of low molecular weight polymer (wax) along with desired molecular weight polyethylene.

The present invention discloses a simple single step process for the preparation of silicon derivative free catalyst system having high surface area from mixed alkoxide precursor [Mg(OR₁)(OR₂) e.g. R₁=ethoxy, R₂=methoxy, propoxy, butoxy]: magnesium alkoxide precursor with titanium tetrachloride. The process being a single step reaction requires lower reaction time compared to multiple step and higher reaction time known in prior art.

Use of dialkyl dialkoxy silane as external donor shows increase of productivity, better hydrogen response of catalyst for melt index. The dialkyl dialkoxy silane includes dimethyl dimethoxy silane, diethyl diethoxy silane, diisoproyl dimethoxy silane, diisopropyl diethoxy silane, dipropyl dimethoxy silane, dipropyl diethoxy silane, dibutyl dimethoxy silane, dibutyl diethoxy silane.

The titanium supported magnesium dichloride catalyst is synthesized by reaction of mixed alkoxide precursor [Mg(OR₁)(OR₂) e.g. R₁=ethoxy, R₂=methoxy, propoxy, butoxy]: magnesium alkoxide precursor with titanium tetrachloride in chlorinated solvent in short reaction time. External electron donor is added during polymerization along with co-catalyst (triethyl aluminum). External donor alters steric and electronic environment around active titanium species affecting productivity and molecular weight distribution.

The polymer resin prepared by the claimed catalyst system shows higher bulk density and better flow properties compared to polymer prepared without adding disclosed external donors. The molecular weight study of resin produced by using external donor shows: narrowing of molecular weight distribution (MWD) due to reduction in weighted average molecular weight. The disclosed catalyst system has also ability to produce ultra high molecular weight polyethylene.

The synthesis of catalyst is conducted in a reactor. The steps comprise reaction of magnesium mixed alkoxide about 0.089 mol [magnesium (19-23 wt %), ethoxy (66-72 wt %), methoxy (5-9 wt %)] M.W=112; mean particle size about 15-80 micron; with about 0.54 mole TiCl₄ (Mw=190 g/mol) in chlorobenzene at about 110° C. for about 120 min at about 100 rpm; allowing the solid to settle for about 30 to 60 minutes; separating liquid by decantation; washing with chlorobenzene and hexane for removal of free titanium species; and drying in nitrogen steam. Surface area of the catalyst prepared is in the range of about 490-520 m²/g. The porosity of the catalyst is in the range of about 0.38-0.48 cm³/g. The ratios of the ingredients of the catalyst on mol basis is: Mg:Ti:Cl:OEt˜1:0.28 to 32:2.7 to 3.0:0.1 to 0.6.

The ethylene polymerization of synthesized catalyst is conducted in a Continuous Stirred Tanks Reactor (CSTR) reactor in n-hexane medium. TEAl/Ti (TE is triethyl) (cocatalyst to catalyst) molar ratio is kept about 200±10 for polymerization. n-Hexane is charged into the reactor and saturated with ethylene for about 10 min. After depressurizing, mixture of (Triethyl Aluminum) TEAl and catalyst (about 80±2 mg) is added into the reactor; followed by hydrogen to achieve 1 bar reactor pressure. The reactor temperature is maintained at about 60±2° C. with total pressure of about 6±0.1 bar (ethylene pressure=5±0.1 bar) for about 1 hr. at 400 rpm. After 1 hr., the reactor is depressurized and cooled to room temperature. The slurry is filtered and the polymer is dried until constant weight. The productivity is calculated based on polymer yield and catalyst quantity (calculated by titanium estimation method). Activity for ethylene polymerization is about 4600 gPE/gcat.

Surface area of catalyst is measured on Sorptomatic 1990 instrument by BET method. Catalyst samples are degassed under high vacuum to constant weight and measurement of adsorption and desorption completed at liquid nitrogen temperature using pure nitrogen gas. BET surface area and pore volume are computed using standard software. Particle size distribution is analyzed using CILAS make particle size analyzer (model-1180) based on laser diffraction methodology.

Molecular weight characteristics of polyethylene produced is determined using Polymer Laboratories PLGPC220 High Temperature Chromatograph instrument (columns: 3× Plgel Mixed-B 10 μm) using two detectors (viscometer and refractometer) in 1,2,4-trichlorobenzene (TCB) as solvent at flow rate of 1 mL/min at 145° C. The system is calibrated with polystyrene standards using universal calibration. Sieve analysis study is performed by standard sieve instrument (Retsch, Germany) with vibration screens for 10 minutes vibration time. Melt flow index is obtained by standard MFI machine at 190° C. (Dynesco Inc). Melting point of synthesized PE is evaluated by DSC instrument (Perkin elmer DSC-7). To determine the flowability of the resin, weighed amount of resin is allowed to fall down through a slit on to the weighing scale of an indigenously designed instrument (M/s Purnina Enterprises, India). Time taken for the flow of resin is monitored. Morphology study is done using FEI INSPECT-S scanning electron microscope (with working distance of 10 mm and 12.5 kV supply voltage).

The present invention is illustrated and supported by the following examples. These are merely representative examples and optimization details and are not intended to restrict the scope of the present invention in any way.

### Example-1

### Catalyst Synthesis and its Physico-Chemical Characteristics, Polymerization (without Addition of External Donor) and Polymer Characteristics Studies

The synthesis of catalyst is conducted in three necked glass reactor (2 L capacity) fitted with turbine type two blade agitator. Reaction of 0.089 mole magnesium mixed alkoxide [Mg=22.1 wt %, ethoxy=68.1 wt %, methoxy=8.0 wt %, M.W=112, mean particle size—26 micron with D10=9, D50=27 & D90=49 micron with 0.54 mole TiCl₄ (Mw=190 g/mol) in 180 ml chlorobenzene at 110° C. were carried out and is held for 120 min at 100 rpm. Settling of solid is allowed for 30 minutes and liquid portion is separated by decantation. Three times washing is given with 100 ml chlorobenzene and with 100 ml hexane each for removal of free titanium species followed by drying in nitrogen steam.

The ethylene polymerization of synthesized catalyst is conducted in 400 ml stainless steel CSTR reactor in n-hexane medium. TEAl/Ti (cocatalyst to catalyst) molar ratio is kept as 200±10 for polymerization. n-Hexane (100 mL) is charged into the reactor and saturated with ethylene for 10 min. After depressurizing, mixture of TEAl and catalyst (80±2 mg) is added into the reactor. Hydrogen is also added to have 1 bar reactor pressure. The reactor temperature is then maintained at 60±2° C. with total pressure of 6±0.1 bar (ethylene pressure=5±0.1 bar) for 1 h at 400 rpm. After 1 h, the reactor is depressurized and cooled to room temperature. The slurry is filtered and the polymer is dried until constant weight. The productivity is calculated based on polymer yield and catalyst quantity (calculated by titanium estimation method).

Surface area of catalyst; BET surface area; pore volume and particle size distribution are computed and analysed as described hereinbefore. Molecular weight characteristics of polyethylene produced; sieve analysis study; melt flow index; melting point of synthesized PE; morphology and flowability is also determined.

TABLE 1
Catalyst physico-chemical characteristics and polymerization/resin results

| Sr No | Characteristics | Value |
|---|---|---|
| 1 | Catalyst composition (mol basis) | Mg:Ti:Cl:OEt~ |
| | | 1:0.31:2.81:0.48 |
| 2 | Surface area (m²/g), porosity (cm³/g) | 500, 0.43 |
| 3 | Catalyst PSD (D₁₀, D₅₀, D₉₀, Mean) in micron | 24, 36, 48 (34) |
| 4 | Activity for ethylene polymerization (gPE/gcat) | 4600 |
| 5 | Bulk density, untapped (g/ml) | 0.29 |
| 6 | Resin particle size distribution by sieve analysis | >2000μ = 0 |
| | | 2000 − 1000μ = 0 |
| | | 1000 − 500μ = 16 |
| | | 500 − 250μ = 18 |
| | | 250 − 125μ = 29 |
| | | 125 − 75μ = 21 |
| | | <75μ = 16 |
| 7 | Molecular weight distribution by GPC^{a} | Mₙ = 6.2 × 10⁴ |
| | | M_{w} = 3.6 × 10⁵ |
| | | PD = 5.8 |
| 8 | Melting temperature of polyethylene^{a} (° C.) | 132.7 |
| 9 | MFI (g/10 min) at 2.16 Kg/Cm² | 0.08 |
| | MFI (g/10 min) at 6.48 Kg/Cm² | 0.44 |
| | Stress Exponent = | 2.0 |
| | [(MFI)_{6.48}/MFI_{2.16}]/Log(3) | |

^{a}DSC condition − art temperature = 50° C., end temperature = 220° C., heating and cooling rate = 10° C./min,

These results show that polyethylene catalyst produced using magnesium mixed alkoxide (single step and lesser time) has higher activity for ethylene polymerization. Also the catalyst has higher surface area and porosity. The polymer resin obtained has broad MWD wherein majority of particles in the range of 125-250 micron. DSC studies show linear nature of polyethylene.

### Example-2

### Catalyst Synthesis and its Physico-Chemical Characteristics, Polymerization (with Addition of DMDMS During Polymerization) and Polymer Characteristics Studies

The synthesized catalyst of Example-1 is evaluated for slurry polymerization performance with addition of DMDMS (Dimethyl dimethoxy silane), as external donor, along with TEAL at Al/DMDMS molar ratio of 30±2. Polymerization is carried out as per procedure followed in Example-1. The polymerization and resin properties (carried out as per procedure in Example-1) results are shown in Table 2.

TABLE 2
Catalyst physico-chemical characteristics and polymerization/resin results

| Sr No | Characteristics | Value |
|---|---|---|
| 1 | Productivity (gPE/gcat) | 6000 |
| 2 | Bulk density, untapped (g/ml) | 0.34 |
| 3 | Resin particle size | >2000μ = 0 |
| | distribution by sieve analysis | 2000 − 1000μ = 0 |
| | | 1000 − 500μ = 84 |
| | | 500 − 250μ = 15 |
| | | 250 − 125μ = 1 |
| | | 125 − 75μ = 0 |
| | | <75μ = 0 |
| 4 | Molecular weight distribution by GPC | Mₙ = 6.6 × 10⁴ |
| | | M_{w} = 2.5 × 10⁵ |
| | | PD = 3.8 |
| 5 | Melting temperature of polyethylene^{a} (° C.) | 133.8 |
| 6 | MFI (g/10 min) at 2.16 Kg/Cm² | 0.141 |
| | MFI (g/10 min) at 6.48 Kg/Cm² | 0.74 |
| | Stress Exponent = [(MFI)_{6.48}/MFI_{2.16}]/Log(3) | 1.5 |

^{a}DSC condition − art temperature = 50° C., end temperature = 220° C., heating and cooling rate = 10° C./min,

Results of Table 2 indicate that polyethylene catalyst with DMDMS showed higher productivity compared to polymerization of same catalyst carried out without external donor. MWD study indicates narrow polydispersitiy (MWD) with DMDMS. This is further substantiated by lower SE (stress exponent) value with DMDMS. Generally lower value of SE indicates narrow molecular weight distribution. Resin particle size study by sieve analysis indicates higher fraction for 500-1000μ in case of DMDMS indicating increase in resin particle size due to higher productivity. Bulk density has also showed improvement for PE synthesized with DMDMS.

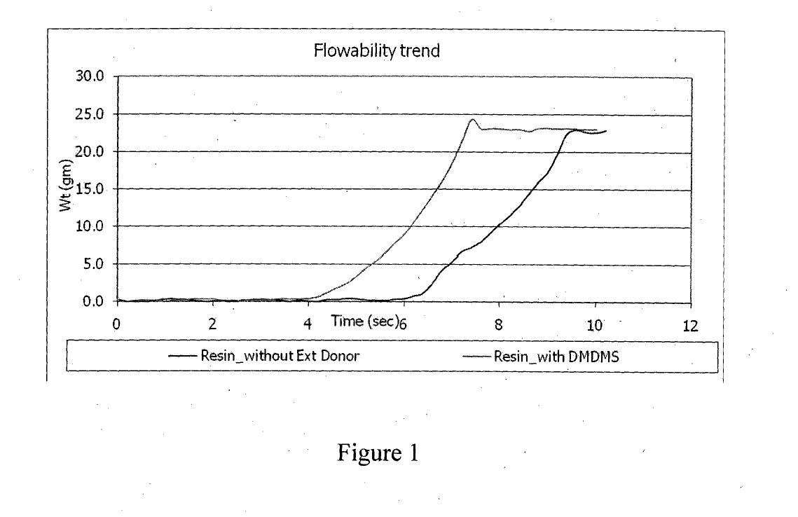

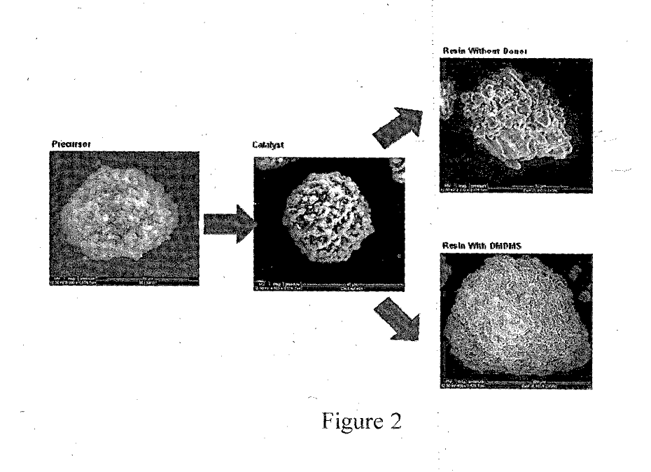

Flowability study indicates better flowability in case of resin synthesized by DMDMS (FIG. 1). Resin produced by DMDMS flow through slit in 7.3 second compared to resin produced without external donor which takes 9.4 seconds indicating better flowability of resin. The finding is further substantiated by polymer resin topography which shows much smoother surface for resin synthesized by DMDMS. Procatalyst to resin exhibits replication of shape comparable to precursor shape (FIG. 2).

FIG. 2 indicates that surface of resin is visibly smoother in case of resin produced by DMDMS as compared to resin produced without use of external donor. Also in both cases, shape of precursor is found to be replicated in procatalyst which is further, replicated in polymer resin also.

### Example-3

### Comparative Catalyst Synthesis, Physico-Chemical Characteristics and its Polymerization Studies

0.087 mol magnesium ethoxide (Mg=21%, ethoxy=80.0 wt %, M.W=114, particle size—24 micron) was reacted with 0.017 gmol TiCl₄ with slow addition in 4 hrs at 85° C. in 200 ml decane. After 0.5 hrs of reaction at 85° C., 0.0086 mol SiCl₄ (Mw=169.9 g/gmol) was also added in 4 hrs at 85° C. and kept for 0.5 hrs at 85° C. and reaction content was heated to 110° C. Later, 0.06 mol TEAl (10% in decane, MW=114 g/mol) was added to reaction mixture in 2 hrs at 110° C. and held at 110° C. for 2 hrs. Settling of solid was allowed for 30 minutes (max 60 min) and liquid portion was separated by decantation. Three times washing was given with 100 ml chlorobenzene and with 100 ml hexane each for removal of free titanium species followed by drying in nitrogen steam. The catalyst physico-chemical characteristics and its polymerization results are shown in Table 3.

TABLE 3
Catalyst physico-chemical characteristics and polymerization results

| Sr No | Characteristics | Value |
|---|---|---|
| 1 | Catalyst composition (mol basis) | Mg:Ti:Cl:OEt:Al:Si~ |
| | | 1:0.22:2.60:0.90:0.15:0.14 |
| 2 | Surface area (m²/g), | 286, 0.31 |
| | porosity (cm³/g) | |
| 3 | Activity for ethylene | 1100 gPE/gcat |
| | polymerization | |

The results indicate lower surface area and productivity compared to results in Example-1.

### Advantages of the Present Invention

1. The catalyst system of the present invention reduces fouling of reactor.
2. The catalyst system of the present invention has high surface area.
3. The process for preparing the catalyst system of the present invention is a simple single step process.
4. Enhanced polymerization efficiency/productivity is achieved using the catalyst system of the present invention.
5. The polymer obtained has narrow molecular weight distribution.
6. The resin obtained has high flowability and bulk density.

1. A high surface area silicon derivative free magnesium-titanium catalyst system for ethylene polymerization comprising: magnesium mixed alkoxide of formula Mg(OR₁)(OR₂) wherein R₁ is ethoxy, R₂ is methoxy, propoxy or butoxy; and titanium chloride.

2. The catalyst system of claim 1 wherein said magnesium mixed alkoxide comprises 19 to 23 wt % of magnesium; 66 to 72 wt % of ethoxy; 5 to 9 wt % of methoxy; has a molecular weight of about 112 g/mol; and mean particle size of about 15-80 micron.

3. The catalyst system of claim 1 wherein ratios of magnesium:titanium:chloride:alkoxide on mol basis is: 1:0.28 to 32:2.7 to 3.0:0.1 to 0.6.

4. The catalyst system of claim 1 wherein the surface area of said catalyst system is in the range of 490 to 520 m²/g.

5. The catalyst system of claim 1 wherein the porosity of said catalyst system is in the range of 0.38 to 0.48 cm³/g.

6. The catalyst system of claim 1 wherein said catalyst system prevents formation of low molecular weight polymer and reduces fouling of reactor.

7. The catalyst system of claim 1 wherein said catalyst system further comprises external donor dialkyl dialkoxy silane of formula R₁₍₂₎(Si)OR₂₍₂₎ wherein R₁ is alkyl or aryl group and R₂ is alkyl group; and a co-catalyst for polymerization.

8. The catalyst system of claim 1 wherein said dialkyl dialkoxy silane is selected from the group comprising dimethyl dimethoxy silane, diethyl diethoxy silane, diisoproyl dimethoxy silane, diisopropyl diethoxy silane, dipropyl dimethoxy silane, dipropyl diethoxy silane, dibutyl dimethoxy silane, dibutyl diethoxy silane or combinations thereof.

9. The catalyst system of claim 1 wherein said co-catalyst is triethyl aluminum.

10. A process for preparing high surface area silicon derivative free magnesium-titanium catalyst system for ethylene polymerization comprising reacting about 0.089 mole magnesium mixed alkoxide with about 0.54 mole titanium chloride in chlorobenzene; settling for about 30 to 60 minutes; separating liquid; washing for removing free titanium; and drying.

11. The process for preparing the catalyst system of claim 10 wherein said magnesium mixed alkoxide comprises 19 to 23 wt % of magnesium; 66 to 72 wt % of ethoxy; 5 to 9 wt % of methoxy; has a molecular weight of about 112 g/mol; mean particle size of about 15-80 micron; and said titanium chloride has a molecular weight of about 190 g/mol.

12. The process for preparing the catalyst system of claim 10 wherein said magnesium mixed alkoxide is reacted with titanium chloride in chlorobenzene at about 110° C. for about 120 min at about 100 rpm.

13. The process for preparing the catalyst system of claim 10 wherein said separating is by decantation.

14. The process for preparing the catalyst system of claim 10 wherein said washing for removing free titanium is with chlorobenzene and hexane.

15. The process for preparing the catalyst system of claim 10 wherein said drying is in nitrogen steam.

16. The process for preparing the catalyst system of claim 10 further comprising adding external donor dialkyl dialkoxy silane of formula R₁₍₂₎(Si)OR₂₍₂₎ wherein R₁ is alkyl or aryl group and R₂ is alkyl group; and the co-catalyst is triethyl aluminum.

17. A high surface area silicon derivative free magnesium-titanium catalyst system prepared by the process of claim 10.

18. A process for ethylene polymerization comprising:
(a) charging n-hexane into a reactor;
(b) saturating the reactor with ethylene;
(c) adding the catalyst system of claim 16 into said reactor;
(d) adding hydrogen to achieve 1 bar reactor pressure;
(e) maintaining reactor temperature at about 60±2° C. with total pressure of about 6±0.1 bar (ethylene pressure=5±0.1 bar) for about 1 hr. at 400 rpm;
(f) depressurizing the reactor;
(g) cooling to room temperature to obtain slurry;
(h) filtering the slurry to obtain polymer; and
(i) drying the polymer.

19. The process for ethylene polymerization of claim 18 wherein said reactor is a Continuous Stirred Tank Reactor.

20. The process for ethylene polymerization of claim 18 wherein said charging n-hexane into reactor is for about 10 min.

21. The process for ethylene polymerization of claim 19 wherein activity for ethylene polymerization is about 4600 gPE/gcat.

22. The polymer obtained by the process of claim 18 wherein said polymer has narrow molecular weight distribution in the range of 3.8 to 4.2 and high bulk density in the range of 0.33 to 0.36.

23-27. (canceled)
